(19) United States
(12) Patent Application Publication
(10) Pub. No.: US 2006/0054717 A1
(43) Pub. Date: Mar. 16, 2006

(54) AC/DC converter with multiple output cords having variable voltage

(76) Inventors: Timothy Alan Dietz, Austin, TX (US); Lane Thomas Holloway, Pflugerville, TX (US); Carol Angela Logan, Austin, TX (US)

Correspondence Address: JANIS E. CLEMENTS, 3112 LOMITA DRIVE, AUSTIN, TX, 78738, US

(21) Appl. No.: 10/942,449

(22) Filed: Sep. 16, 2004

(51) Int. Cl. A62C 13/62

(52) U.S. Cl. 239/302

(57) ABSTRACT

A system, method, and related computer program for an AC/DC converter with multiple output cords having variable voltage. A user can use multiple computer components at one time and can vary the voltage on various output cords that service computer components. The present invention allows a user to retract output cords when not in use. The voltage amount for a selected output cord is shown in the indicator display, while indicator lights indicate whether its corresponding output cord is available for use. A green indicator light indicates the cord is available, and a red indicator light indicates the cord is already in use. Once an output cord is selected by a selector switch, the user can vary the output cord's voltage by adjusting a user input device to increase or decrease the voltage for that output cord. Once the desired voltage is reached, the selection is finalized by activating a “set” button.

### TECHNICAL FIELD

The present invention relates to computer controlled consumer electronics devices or instruments, such as laptop computers, speakers, printers, wireless routers, and the like, and specifically to the AC/DC conversion necessary for these electronic devices to function.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years to now come into great demand in the marketplace.

The rapid expansion in the capacity of computers to perform support functions, the increase in availability of various equipment components, such as laptop computers, printers, speakers, wireless routers, and the like. A key aspect of this expansion has been an increase in output cords and a shortage in available outlets into which users can plug their equipment. In fact, many users are forced to choose which components they can plug in at one time due to the lack of available outlets. Another hindrance with the current increase in computer components is the amount of various electrical cords that are present. This invention provides for multiple retractable output cords with variable voltage for use with computer attachments.

AC/DC conversion is currently achieved by either the use of transformers or the use of semiconductors. When selecting an AC adapter, a user must match the voltage, tip polarity, and tip size exactly, however, the adapter only needs to match the current consumption at a minimum. Since a device will only pull as much current as it needs, and since adapters are rated at the maximum current they can provide, there is no problem using an adapter which is rated at a higher current than is required by the device. The present invention requires only the voltage to be variable due to the nature of DC devices. The present invention involves multiple output cords, each having its own “tweakable” AC to DC converter, using as much shared circuitry as possible with the other output cords to minimize bulk.

There already exists a universal AC to DC power supply, however it does not use a variable regulated power supply, also called a variable bench power supply. With a variable regulated power supply, a user can continuously adjust the output voltage to meet the voltage requirements of the user. Varying the output of the power supply has traditionally been used when a user is testing an electrical project after having double checked parts placement against circuit drawings and a parts placement guide. When testing a project using a variable power supply, the user starts with a minimum voltage, and then looks for signs of distress among components then progressively increases the voltage to a recommended project voltage while continually monitoring the project for distress.

### SUMMARY OF THE PRESENT INVENTION

The present invention provides a solution to the problems related to the difficulty and inconvenience of multiple cords associated with the use of multiple computer components. Accordingly, the present invention provides for multiple retractable output cords with variable voltage for use with computer attachments. The multiple output cords of the present invention comprise interchangeable heads to correspond with various electronic devices or components to which they will be connected. An indicator display, such as an LED indicator display, shows the voltage range of a particular output cords when selected by a selector switch. The voltage can be varied on the selected output cord by using a user input device, such as a knob, to increase or decrease the voltage for that cord. A “set” button is then activated to finalize the setting selection made with the selector switch and user input device. Indicator lights, such as LED indicator lights, are located beside each output cord to indicate whether its corresponding output cord is in use. A red indicator light signals the user that the corresponding output cord is in use. When an indicator light is green, its corresponding output cord is available for use.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic illustration of an AC/DC converter with multiple output cords having variable voltage;

FIG. 2 is a side view of an AC/DC converter with multiple cords having variable voltage;

FIG. 3 is an illustrative flowchart in accordance with this invention showing how the AC/DC converter can vary voltage to an output cord with respect to its corresponding device; and

FIG. 4 is a flowchart of an illustrative run of the process set up in FIG. 3.

### DETAILED DESCRIPTION OF THE PREFERRED EMBODIMENT

Referring to FIG. 1, a typical use of the AC/DC converter with multiple output cords is shown. The AC/DC converter 12 has multiple output cords 14 that each has variable voltage so that can be “tweaked” to use as much shared circuitry as possible with the other output cords to minimize bulk. The output cords have interchangeable heads 16 to correspond with their associated electronic devices they are to power. FIG. 1 also shows an indicator display 18, such as an LED indicator display, which indicates amount voltage being used by a particular output cord selected by a selector switch 24. Also shown in FIG. 1 are the indicator lights 20, such as LED indicator lights, located beside each corresponding outlet indicating whether its output cord is in use by a red light, and a green light when the output cord is available for use. A user input device 22, such as a knob, is used for modifying voltage between minimum and maximum values to an output cord selected by the selector switch 24. A “set” button 26 finalizes the setting choice made by the user input device 22 and the selector switch 24. When the “set” button 26 is activated, the values of the resistors associated with the selected output are modified.

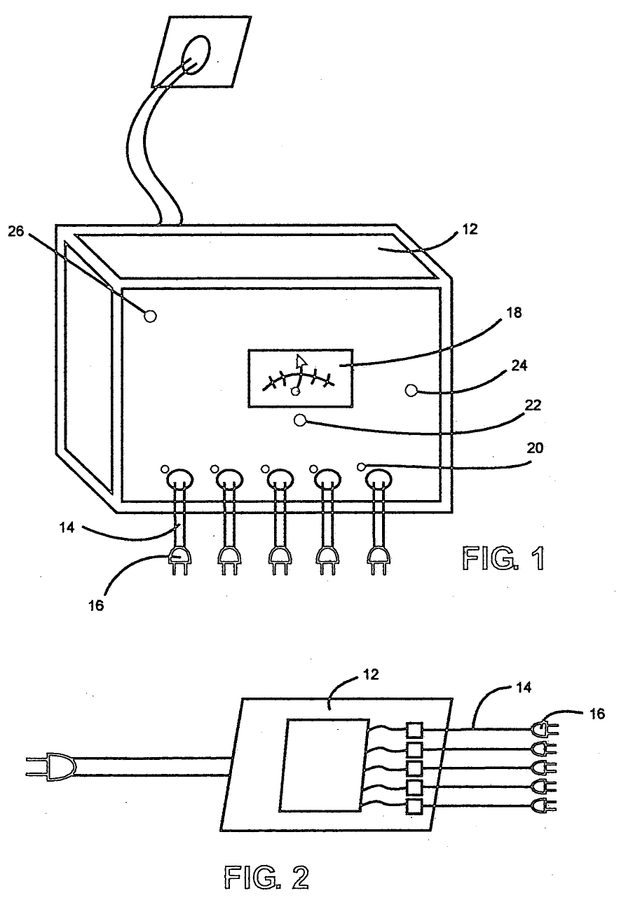

An AC/DC converter, illustrated in FIG. 2, comprises multiple output cords 14 as described above that have variable voltage. The output cords 14 are retractable. In the simplified illustration of FIG. 2, an output cord's voltage is “tweaked” or modified to correspond to the needs of a device the output cord 14 is used to power.

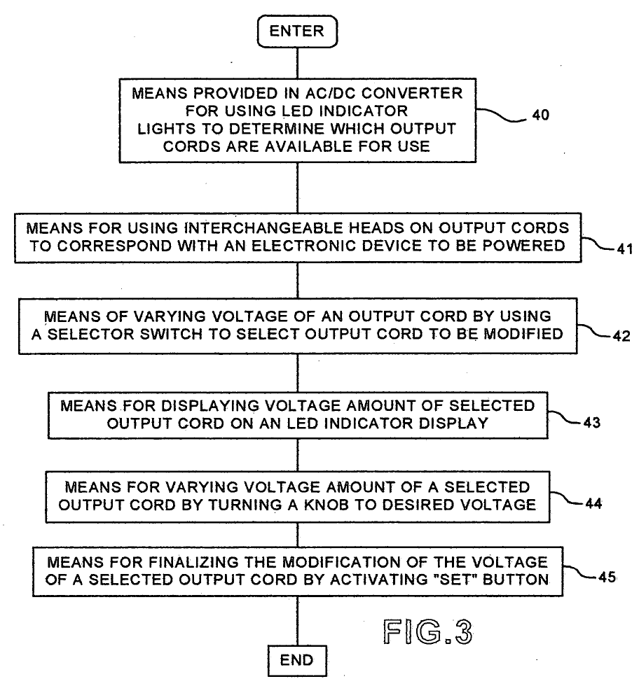

The running of the process set up in FIGS. 1 and 2 will now be described with respect to the flowchart of FIG. 3. The flowchart represents some steps in a routine that will illustrate the operation of the invention. Means provided in an AC/DC converter for using indicator lights to determine which output cords are available for use, step 40. Means for using interchangeable heads on an output cord available for use to correspond with an electronic device to be powered, step 41. Means of varying voltage of an output cord by using a selector switch to select the output cord to be modified, step 42. Means for displaying voltage amount of selected output cord on an indicator display, step 43. Means for varying voltage amount of a selected output cord by adjusting a user input device to desired voltage, step 44. Means for finalizing the modification of the voltage of a selected output cord by activating the “set” button, step 45.

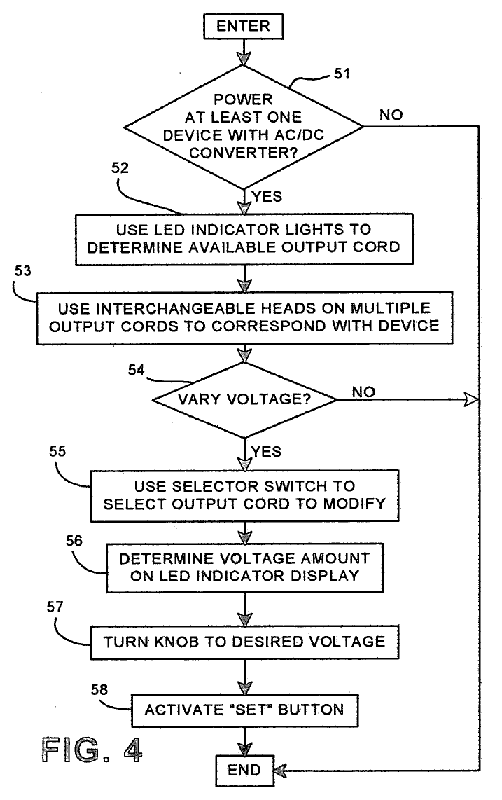

Referring now to FIG. 4, an illustrative flowchart in accordance with this invention showing how the AC/DC converter with multiple output cords varies voltage for the output cords. A determination is made as to whether the user wants to power at least one electronic device with an AC/DC converter, step 51. If No, the process ends. If Yes, the user uses indicator lights beside their corresponding output cords to determine whether an output cord is available for use, step 52. A green indicator light indicates the output cord is available for use, while a red indicator light indicates the output cord is already in use. The user then uses interchangeable heads on the multiple output cords that correspond with the electronic device the user is wanting to power with the AC/DC converter, and plugs the electronic device or devices into the AC/DC converter via the interchangeable heads on the output cords, step 53. A determination is then made regarding whether the user wants to vary the voltage of the output cords, step 54. If No, the process ends. If Yes, the user uses the selector switch to select the output cord the user wants to modify, step 55. The user notes the voltage amount of the output cord selected by the selector switch on the indicator display, step 56. The user then adjusts the user input device to the desired voltage for the output cord, step 56. The “set” button then must be activated to finalize the modification of the voltage for the selected output cord, step 57, and the process ends.

Although certain preferred embodiments have been shown and described, it will be understood that many changes and modifications may be made therein without departing from the scope and intent of the appended claims.

What is claimed is:

1. An AC/DC converter, comprising:
a plurality of output cords;
each of said output cords having variable voltage;
each of said output cords having a head receivable by a corresponding electronic devices;
an indicator display showing voltage range;
an indicator light beside each corresponding output cord indicating whether its output cord is in use; and
a user input device for modifying voltage to a selected output cord.

2. The AC/DC converter of claim 1 wherein each of said heads is interchangeably replaceable.

3. The AC/DC converter of claim 1 wherein the output cords are retractable.

4. The AC/DC converter of claim 1 wherein the indicator light is red when its corresponding output cord is in use.

5. The AC/DC converter of claim 1 wherein the indicator light is green when its corresponding output cord is available for use.

6. The AC/DC converter of claim 1, further comprising a selector switch for selecting an output cord to have its voltage modified by the user input device.

7. The AC/DC converter of claim 6, further comprising a “set” button for finalizing setting selection made with the selector switch.

8. A method for converting AC/DC power, including the steps of:
plugging a plurality of output cords, each of said output cords having variable voltage, each of said output cords having a head receivable by a corresponding electronic device, into an AC/DC converter;
displaying voltage range via an indicator;
indicating whether an output cord is in use via an indicator light beside each corresponding output cord; and
modifying voltage to a selected output cord via a user input device.

9. The method of claim 8 wherein each of said heads is interchangeably replaceable.

10. The method of claim 8 wherein the output cords are retractable.

11. The method of claim 8 wherein the LED indicator light is red when its corresponding output cord is in use.

12. The method of claim 8 wherein the LED indicator light is green when its corresponding output cord is available for use.

13. The method of claim 8, further comprising a selector switch for selecting an output cord to have its voltage modified by the user input device.

14. The method of claim 13, further comprising a “set” button for finalizing setting selection made with the selector switch.

15. A computer program having code recorded on a computer readable medium for an AC/DC converter, comprising:
means for plugging a plurality of output cords with variable voltage, each of said output cords having a head receivable by a corresponding electronic device, into the AC/DC converter;
means for displaying voltage range via an indicator;
means for indicating whether an output cord is in use via an indicator light beside each corresponding output cord; and
means for modifying voltage to a selected output cord via a user input device.

16. The computer program of claim 15 wherein the output cords are retractable.

17. The computer program of claim 15 wherein the indicator light is red when its corresponding output cord is in use.

18. The computer program of claim 15 wherein the indicator light is green when its corresponding output cord is available for use.

19. The computer program of claim 15, further comprising a selector switch for selecting an output cord to have its voltage modified by the user input device.

20. The computer program of claim 19, further comprising a “set” button for finalizing setting selection made with the selector switch.
